(19) United States
(12) Patent Application Publication
(10) Pub. No.: US 2026/0180929 A1
(43) Pub. Date: Jun. 25, 2026

(54) PROMPT GENERATION SUPPORT APPARATUS AND PROMPT GENERATION SUPPORT METHOD

(71) Applicant: Hitachi, Ltd., Tokyo (JP)

(72) Inventor: Hajime KANZAKI, Tokyo (JP)

(21) Appl. No.: 19/407,042

(22) Filed: Dec. 3, 2025

(30) Foreign Application Priority Data
Dec. 25, 2024 (JP) 2024-228531

(51) Int. Cl. H04L 51/02; G06F 40/40; H04L 41/16; H04L 45/302; H04L 51/046

(52) U.S. Cl. CPC H04L 51/02; G06F 40/40; H04L 41/16; H04L 45/3065; H04L 51/046

(57) ABSTRACT

A prompt generation support apparatus and a prompt generation support method assisting in the generation of prompts for producing support information take into account communication restrictions in the communication paths through which on-site information is transmitted. The prompt generation support apparatus includes a memory and a processor. The memory stores communication status of a communication path used for communication to a user terminal, and a communication path used for communication to a device located at a site, the device being configured to acquire site information related to the site. The processor acquires support request information related to a request for operational support from a user, generates restriction information for limiting the device that acquires the site information based on the communication status of the communication path through which the site information is transmitted, and generates a support request prompt based on the support request information and the restriction information.

### CROSS-REFERENCE TO RELATED APPLICATION

The present application claims priority from Japanese application JP 2024-228531, filed on Dec. 25, 2024, the content of which is hereby incorporated by reference into this application.

### Technical Field

The present disclosure relates to a prompt generation support apparatus and a prompt generation support method.

### Background Art

In recent years, generative AI has been utilized in technologies that support on-site users, such as surveillance systems using cameras. As prior art related to the generative AI, Patent Document 1 is known. Patent Document 1 discloses a sentence generation apparatus (hereinafter referred to as “Conventional Apparatus 1”) that generates a prompt for input into a large-scale model by adding reference information to an input question sentence.

Conventional Apparatus 1 generates a prompt by obtaining candidate sentences related to the input question sentence, which are used to generate additional sentences to be added as reference information to the question sentence, and by adding the additional sentences generated based on the candidate sentences as reference information.

### CITATION LIST

### Patent Literature

Japanese Patent Publication No. 7325152

### SUMMARY OF THE INVENTION

### Technical Problem

In a work support system that assists on-site user, the generative AI is utilized to provide operational support. In such a system, a support server uses the generative AI to generate work support information based on support requests received via voice or text from on-site user, together with on-site information acquired by devices such as cameras and sensors, and provides the work support information to the user by transmitting it to a user terminal. However, due to communication restrictions in the communication paths between the on-site devices and the support server, and between the support server and the user terminal, it may not be possible to provide all of the on-site information corresponding to the support information generated by the generative AI to the user.

The present disclosure has been made to address the above problems. One objective of the present disclosure is to provide a prompt generation support apparatus and a prompt generation support method capable of assisting in the generation of a prompt for producing support information that takes into account communication restrictions in the communication path through which on-site information is transmitted.

### Solution to Problem

In order to solve the above problem, the present disclosure prompt generation support apparatus comprises a memory and a processor, wherein the memory is configured to store communication status of a communication path used for communication to a user terminal, and a communication path used for communication to a device located at a site, the device being configured to acquire site information related to the site; and the processor is configured to acquire support request information related to a request for operational support from a user; generate restriction information for limiting the device that acquires the site information based on the communication status of the communication path through which the site information is transmitted; and generate a support request prompt based on the support request information and the restriction information.

The present disclosure prompt generation support method uses a memory and a processor, wherein the memory stores communication status of a communication path used for communication to a user terminal, and a communication path used for communication to a device located at a site, the device being configured to acquire site information related to the site, and the processor acquires support request information related to a request for operational support from a user; generates restriction information for limiting the device that acquires the site information based on the communication status of the communication path through which the site information is transmitted; and generates a support request prompt based on the support request information and the restriction information.

### Advantageous Effect

According to the present disclosure, it is possible to support the generation of a prompt for producing support information that takes into account communication restrictions in the communication path through which on-site information is transmitted. It should be noted that the effect described herein are not necessarily limiting, and any of the effects described throughout the present disclosure may be applicable.

### BRIEF DESCRIPTION OF DRAWINGS

FIG. 1 is a diagram illustrating an example configuration of a work support system.

FIG. 2 is a functional block diagram illustrating an example configuration of a support server.

FIG. 3 is a diagram illustrating an example hardware configuration of a computer applicable to the support server.

FIG. 4 is a diagram for explaining communication status information.

FIG. 5 is a diagram for explaining device management information.

FIG. 6A is a diagram illustrating an example of a work support system applied to railway operations as a reference example.

FIG. 6B is a diagram for explaining an overview of the work support system according to an embodiment of the present disclosure.

FIG. 7A is a diagram illustrating an example of support request information.

FIG. 7B is a diagram illustrating an example of a restriction prompt.

FIG. 7C is a diagram illustrating an example of a support request prompt.

FIG. 8A is a diagram illustrating an example of first support information.

FIG. 8B is a diagram illustrating an example of second support information.

FIG. 9 is a flowchart illustrating a processing flow executed by the support server.

FIG. 10 is a flowchart illustrating another processing flow executed by the support server.

FIG. 11 is a diagram for explaining Equation (1).

### DESCRIPTION OF EMBODIMENTS

Hereinafter, an embodiment of the present disclosure will be described with reference to the drawings. In all the drawings of the embodiment, identical or corresponding parts may be denoted by the same reference numerals.

In the following description, various types of information may be described using terms such as “table,” “record,” “row,” “column,” or “field.” However, such information may also be represented using other data structures. When describing identification information, expressions such as “ID” or “name” may be used interchangeably, and may also be replaced with other forms of identification information.

In the following description, processing may be described using functional blocks as the subject. However, the subject of the processing may alternatively be a CPU or a device. The entity that executes the processing by running a program may be any arithmetic unit, and may include dedicated circuits that perform specific processing. Such dedicated circuits may include, for example, an FPGA (Field Programmable Gate Array), an ASIC (Application Specific Integrated Circuit), or a CPLD (Complex Programmable Logic Device).

A program may be installed into an information processing apparatus from a program source. The program source may be, for example, a program distribution server or a storage medium readable by the information processing apparatus. When the program source is a program distribution server, the server may include a processor and a storage resource that stores the program to be distributed, and the processor of the program distribution server may distribute the program to other information processing apparatuses. In the embodiment, two or more programs may be implemented as a single program, or a single program may be implemented as two or more programs.

### Embodiment

An embodiment of the present disclosure will be described with reference to a work support system including a support server 100. In the following, a work support system applied to railway operations will be described. However, the work support system is not limited to railway operations and may be applied to various other types of operations.

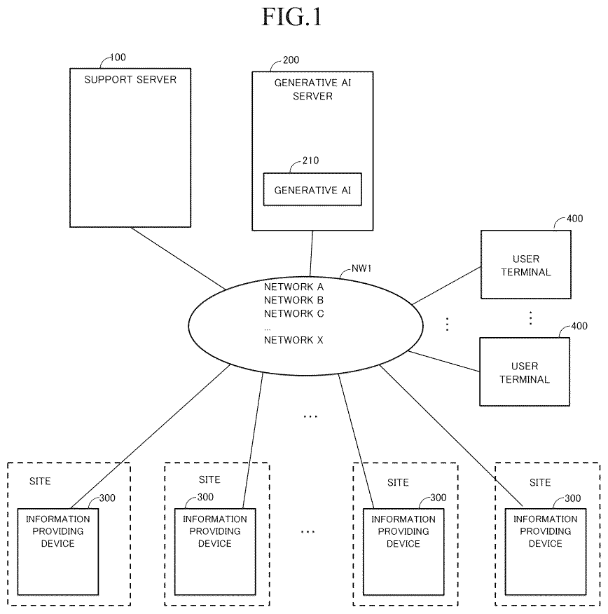

FIG. 1 is a diagram illustrating an example configuration of the work support system. As shown in FIG. 1, the work support system includes the support server 100, a generative AI server 200, a plurality of information-providing devices 300 (hereinafter sometimes referred to as “devices”), and user terminals 400. These components are communicably connected to each other via a network NW1. The network NW1 includes a plurality of networks (e.g., Network A, Network B, Network C, . . . , and Network X). The user and the user terminal 400 used by the user may be located on-site.

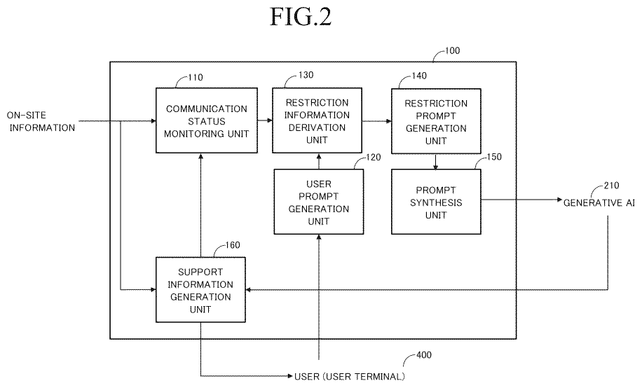

FIG. 2 is a functional block diagram illustrating an example configuration of the support server 100. The support server 100 may also be referred to as a “prompt generation support apparatus” or a “work support apparatus.” As shown in FIG. 2, the support server 100 includes a communication status monitoring unit 110, a user prompt generation unit 120, a restriction information derivation unit 130, a restriction prompt generation unit 140, a prompt synthesis unit 150, and a support information generation unit 160.

The communication status monitoring unit 110 monitors the communication status of each network included in the network NW1. The user prompt generation unit 120 generates a prompt (hereinafter sometimes referred to as a “user prompt”) based on a support request from the user. The restriction information derivation unit 130 acquires information on the communication status of each network from the communication status monitoring unit 110 and derives restriction information based on the communication status information. The restriction information is information for restricting the devices that acquire on-site information. For example, the restriction information may include combinations of the maximum number of devices for acquiring on-site information or throughput limitations for each device. It should be noted that the restriction information derivation unit 130 may also derive the restriction information based on both the communication status information and the user prompt. The restriction prompt generation unit 140 generates a prompt (hereinafter sometimes referred to as a “restriction prompt”) that defines restrictions related to the devices used to acquire on-site information, based on the restriction information. The restriction prompt is used to limit the on-site information included in second support information (i.e., support information provided by the support server 100 to the user terminal 400, as described later). The restriction prompt may be any information that can be processed by the generative AI 210. One example of the restriction prompt is a prompt that limits the location, type, or number of devices, thereby restricting the on-site information included in the second support information. A specific example of the restriction prompt is: “Up to a total of five cameras, including in-vehicle and side cameras, for the train stopped at Station B on Line A, and up to ten station cameras at Station B can be transmitted.” The restriction prompt may also be information corresponding to the type and number of devices. Another specific example of the restriction prompt is: “A combination of side cameras and in-vehicle cameras that satisfies the following conditions: total throughput of 10 Mbps or less; side cameras: 2 Mbps per unit; in-vehicle cameras: 1.5 Mbps per unit.”

The prompt synthesis unit 150 creates a prompt (hereinafter sometimes referred to as a “support request prompt”) by combining the user prompt and the restriction prompt, and inputs the support request prompt into the generative AI 210.

The support information generation unit 160 acquires first support information generated by the generative AI 210 in response to the support request prompt, obtains on-site information corresponding to the first support information, and generates second support information including both the first support information and the on-site information. Because the first support information takes communication restrictions into account based on the restriction prompt included in the support request prompt, the on-site information corresponding to the first support information also reflects the communication restrictions. The support information generation unit 160 provides the second support information to the user by transmitting it to the user terminal 400.

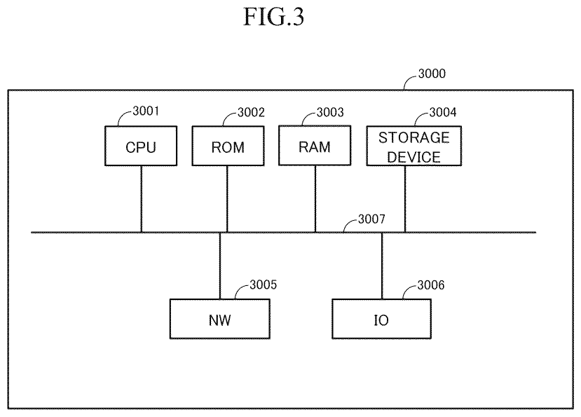

FIG. 3 is a diagram illustrating an example hardware configuration of a computer 3000 applicable to the support server 100. The support server 100 may be implemented using a plurality of computers, or may be a virtual computer deployed on a cloud platform.

The computer 3000 may also be referred to as an “information processing apparatus.” The computer 3000 includes a processor (CPU 3001), a ROM 3002, a RAM 3003, a non-volatile storage device 3004 capable of reading and writing data, a network interface 3005, and an input/output interface 3006. These components are communicably connected to each other via a bus 3007.

The CPU 3001 loads various programs (not shown) stored in the ROM 3002 and/or the storage device 3004 into the RAM 3003, and executes the programs loaded in the RAM 3003 to implement various functions of the support server 100.

In the RAM 3003, various programs executed by the CPU 3001, as described above, are loaded, and data used during the execution of these programs by the CPU 3001 is temporarily stored. The ROM 3002 and/or the storage device 3004 are non-volatile storage media, and various programs are stored therein. The ROM 3002 and/or the storage device 3004 store, as programs, a communication status monitoring unit 110, a user prompt generation unit 120, a restriction information derivation unit 130, a restriction prompt generation unit 140, a prompt synthesis unit 150, and a support information generation unit 160. Additionally, the ROM 3002 and/or the storage device 3004 store communication status information 4000 and device management information 5000, which will be described later.

The network interface 3005 is an interface that allows the computer 3000 to connect to a network. The input/output interface 3006 is an interface that allows the computer 3000 to connect to an input device and a display device capable of displaying images.

The computer 3000 may or may not include a display device. Alternatively, a hardware device in which part or all of the computer 3000 is implemented using, for example, an FPGA (Field Programmable Gate Array), may be used in place of the computer 3000.

The generative AI server 200 includes a language generation AI 210. The language generation AI 210 includes a large language model (LLM). The language generation AI 210 may also be referred to as the “generative AI 210.” The large language model (LLM) is a language model constructed using a large amount of data and deep learning techniques. The generative AI 210 generates an appropriate response (answer) by inputting a given prompt into the large language model, and outputs the generated response (returns it as a response). The generative AI server 200 is implemented using the computer 3000 illustrated in FIG. 3. The generative AI server 200 may be composed of a plurality of computers, or may be a virtual computer deployed on a cloud platform.

The information-providing device 300 is installed at a work site, a monitoring site, or other field locations, and acquires information related to the site, which it provides to the support server 100 via a network. Note that a plurality of information-providing devices 300 may be installed at a single site. The site may be, for example, a vehicle (mobile body), a station, or the like. When the site is a vehicle, the information-providing device 300 may be a surveillance camera installed inside the vehicle (in-vehicle camera) or a surveillance camera mounted on the exterior of the vehicle (external vehicle camera). When the site is a station, the information-providing device 300 may be a surveillance camera installed on the station platform (station camera). The information-providing device 300 may also be a sensor or the like that acquires information about the site.

The user terminal 400 may be, for example, a desktop personal computer (PC), a notebook PC, a smartphone, a tablet, or a command device. At least a part of the user terminal 400 is implemented using the computer 3000 illustrated in FIG. 3.

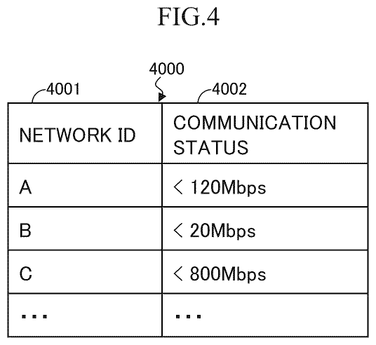

FIG. 4 is a diagram for explaining communication status information 4000. As shown in FIG. 4, the communication status information 4000 includes columns for storing information (values), namely, a network ID 4001 and communication status 4002. The communication status information 4000 stores, as records, information corresponding to each column related to the communication status of each network in an associated manner. Specifically, the network ID 4001 stores an ID for identifying a network. The communication status 4002 stores information indicating the communication status of the network, such as communication bandwidth (Mbps: megabits per second). Note that, if the communication status changes over time, the value of the communication status 4002 may also vary over time.

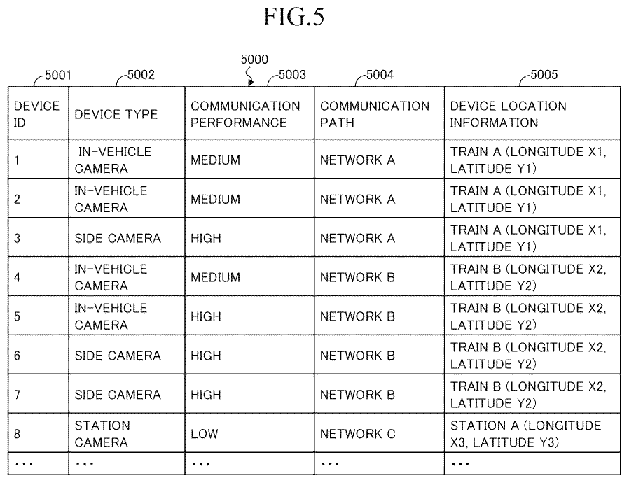

FIG. 5 is a diagram for explaining device management information 5000. As shown in FIG. 5, the device management information 5000 includes columns for storing information (values), namely, a device ID 5001, a device type 5002, a communication performance 5003, a communication path 5004, and a device location information 5005. The device management information 5000 stores, as records, information corresponding to each column related to each device located at the site in an associated manner. Specifically, the device ID 5001 stores an ID for identifying a device (i.e., an information-providing device 300). The device type 5002 stores the type of the device. The communication performance 5003 stores the communication performance of the device. The communication path 5004 stores the name of the network serving as the communication path for the device. The device location information 5005 stores information indicating the location of the device (e.g., the installation site (field), or coordinate information such as latitude and longitude).

### Overview of the Present Disclosure

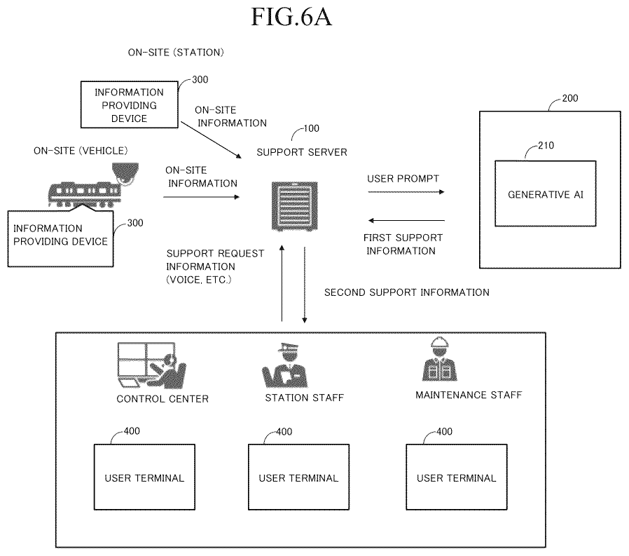

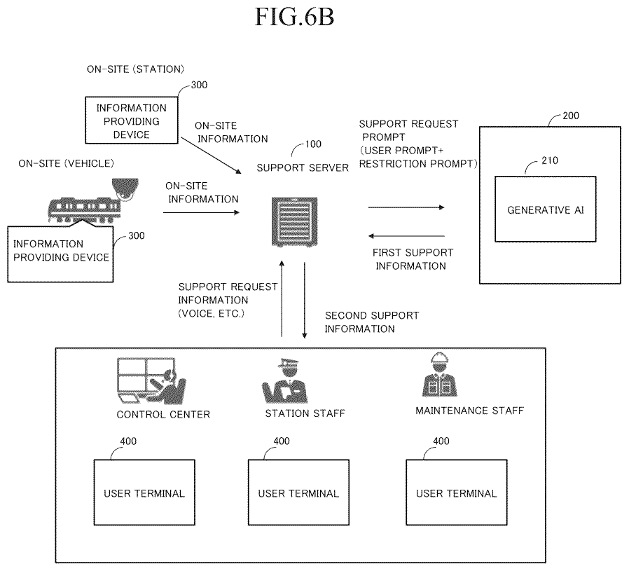

An overview of the present disclosure will now be described. FIG. 6A illustrates an example of a work support system applied to railway operations as a reference example. In the work support system applied to railway operations, the support server 100 collects information from sites such as vehicles (which are mobile bodies) and stations. The support server 100 generates a user prompt based on instructions such as voice input provided by the user (e.g., a dispatcher at a command center, a station staff, or a maintenance personnel) via the user terminal 400, and inputs the user prompt into the generative AI 210. The generative AI 210 then generates first support information. The support server 100 transmits second support information, which includes the first support information and on-site information, to the user terminal 400 of the user who requested the support.

In such a work support system, on-site information is transmitted to the support server 100 via various networks, such as public networks or cloud networks. The on-site information is then transmitted from the support server 100 to the user terminal 400 via such networks. Due to communication conditions (communication restrictions) in the networks through which the on-site information passes, it may become difficult to transmit the information (on-site information) from the information-providing device 300 at the site to the support server 100, and from the support server 100 to the user terminal 400.

The generative AI 210 is required to generate first support information (a response) in accordance with the input user prompt. However, it is difficult for the generative AI 210 to take into account the communication status (communication restrictions) of the network (communication path) through which the on-site information passes. Therefore, it is challenging for the generative AI 210 to generate first support information that reflects the communication status (communication restrictions) of the network through which the on-site information is transmitted. For example, if the first support information includes instructions such as “Please have the on-site station staff check whether any passengers are caught or have come into contact with others by viewing all in-vehicle cameras installed in the train,” then the support server 100 needs to transmit, as second support information, both the first support information and the corresponding on-site information (i.e., video from all in-vehicle cameras installed in the train) to the user terminal 400.

However, depending on the communication status (communication restrictions) of the network (communication path) through which the on-site information passes, it may be difficult to transmit the on-site information (e.g., video from all in-vehicle cameras installed in the train), or even if transmission is possible, it may take a significant amount of time.

In contrast, as illustrated in FIG. 6B, the present disclosure enables the generative AI 210 to understand the communication status of the network (communication path) through which the on-site information passes. Specifically, a support request prompt is created by adding a restriction prompt to the user prompt in accordance with the communication status of the network (communication path), and the support request prompt is input to the generative AI 210. As previously described, the restriction prompt defines restrictions related to the devices used to acquire on-site information. As a result, the first support information (response) and the second support information generated by the generative AI 210 based on the support request prompt reflect the communication status (communication restrictions) of the network (communication path) through which the on-site information passes. Accordingly, the support server 100 of the present disclosure can assist in generating prompt(s) for producing first and second support information that takes into account communication restrictions. Furthermore, the support server 100 can provide appropriate support information (second support information) to the user based on the communication status.

In the work support system illustrated in FIG. 6B, the support server 100 monitors the communication status of each network, including the network between the on-site information-providing device 300 and the user terminal 400, and the network between the user terminal 400 and the support server 100. The support server 100 acquires support request information including a support request from the user via voice or text input, and generates a user prompt. The support request information may include information related to the location from which the information is to be acquired (e.g., station name or location information obtained from GPS).

The support server 100 generates restriction information based on the communication status and, based on the restriction information, generates a restriction prompt that defines constraints on the information that can be transmitted in accordance with the communication status. The restriction prompt may be generated by the generative AI 210 in response to an instruction prompt that instructs the generative AI 210 to create the restriction prompt based on the restriction information, and the restriction prompt may be obtained from the generative AI 210. The restriction prompt may also be generated using a format corresponding to the restriction information.

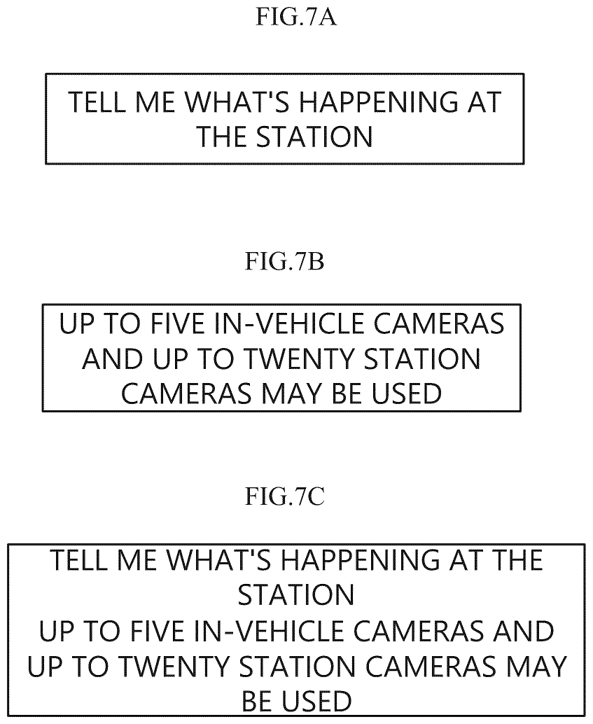

To facilitate understanding of the work support system according to the present disclosure, a specific use case example will be described. For example, it is assumed that an emergency stop button on a station platform is pressed immediately after a train (vehicle) departs from the station. In this situation, a dispatcher at the command center inputs, via the user terminal 400, support request information including voice data as shown in FIG. 7A (e.g., “Tell me what's happening at the station”) into the support server 100. In this example, the support request information includes location information indicating the position of the station. The support server 100 generates a user prompt based on the support request information including the voice data. In this example, the user prompt corresponds to the content shown in FIG. 7A, i.e., “Tell me what's happening at the station”.

The support server 100 extracts devices such as cameras installed in the train (vehicle) located at the site (station) where the emergency stop button was pressed, as well as in the station itself where the emergency stop button was pressed. The support server 100 then derives restriction information based on the status of the networks corresponding to the train and the station (i.e., the communication paths through which on-site information is acquired). Based on the restriction information, the support server 100 generates a restriction prompt as shown in FIG. 7B (e.g., “Up to five in-vehicle cameras and up to twenty station cameras may be used”).

The support server 100 creates a support request prompt, as shown in FIG. 7C, by combining the user prompt and the restriction prompt.

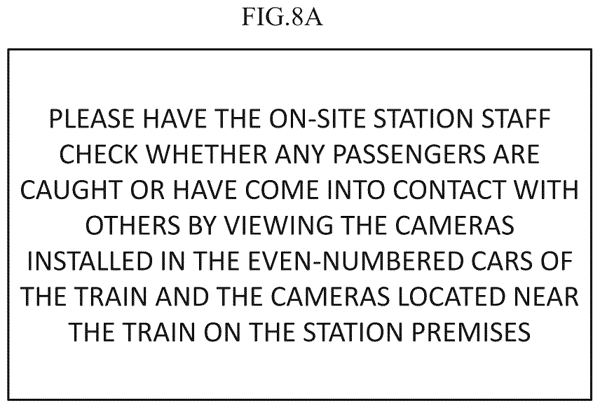

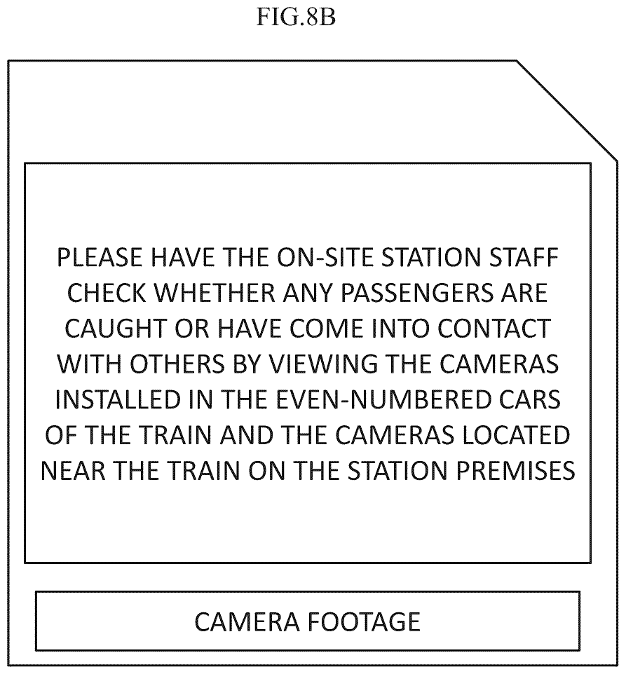

The generative AI 210 generates first support information, as shown in FIG. 8A, based on the support request prompt. For example, the first support information may include instructions such as: “Please have the on-site station staff check whether any passengers are caught or have come into contact with others by viewing the cameras installed in the even-numbered cars of the train and the cameras located near the train on the station premises.” This first support information is generated by the generative AI 210 based on the restriction prompt included in the support request prompt, and thus reflects the constraints defined therein. In this example, considering communication restrictions, the first support information includes instructions to check information from only a restricted set of cameras, specifically the cameras in the even-numbered cars of the train and the station cameras located near the train.

The support server 100 acquires the first support information from the generative AI 210. The support server 100 then provides the first support information and second support information, which includes camera footage corresponding to the first support information as shown in FIG. 8B, to the dispatcher by transmitting the second support information to the user terminal 400 of the dispatcher at the command center. The dispatcher reviews the second support information and takes appropriate action, such as issuing instructions to station staff.

### Detailed Operation

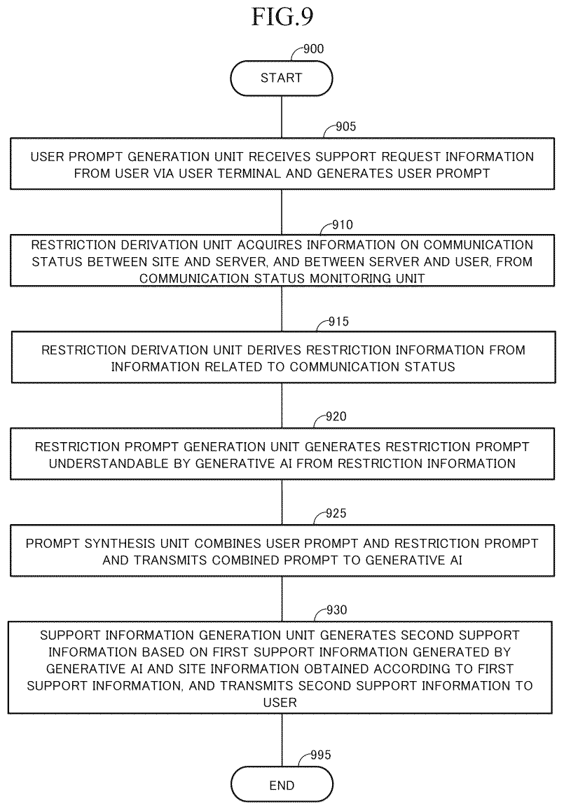

FIG. 9 is a flowchart illustrating a processing flow executed by the support server 100. The support server 100 starts the process at step 900, sequentially executes the processes from step 905 to step 930 as described below, and then proceeds to step 995 to temporarily terminate the processing flow.
Step 905: The user prompt generation unit 120 receives support request information from the user via the user terminal 400 and generates a user prompt.
Step 910: The restriction information derivation unit 130 identifies the on-site information-providing device 300 based on the location information of the data acquisition target included in the support request information and the device management information 5000. The restriction information derivation unit 130 then acquires, from the communication status monitoring unit 110, information on the communication status of a first communication path between the on-site information-providing device 300 and the support server 100, and a second communication path between the support server 100 and the user terminal 400 (i.e., each network through which the on-site information passes).
Step 915: The restriction information derivation unit 130 derives restriction information from the communication status information. Details of the processing in step 915 will be described later.
Step 920: The restriction prompt generation unit 140 generates a restriction prompt, interpretable by the generative AI 210, based on the restriction information.
Step 925: The prompt synthesis unit 150 creates a support request prompt by combining the user prompt and the restriction prompt, and transmits the support request prompt to the generative AI 210.
Step 930: The support information generation unit 160 receives the first support information generated by the generative AI 210, generates second support information based on the first support information and on-site information acquired in accordance with the first support information, and provides the second support information to the user by transmitting it to the user terminal 400.

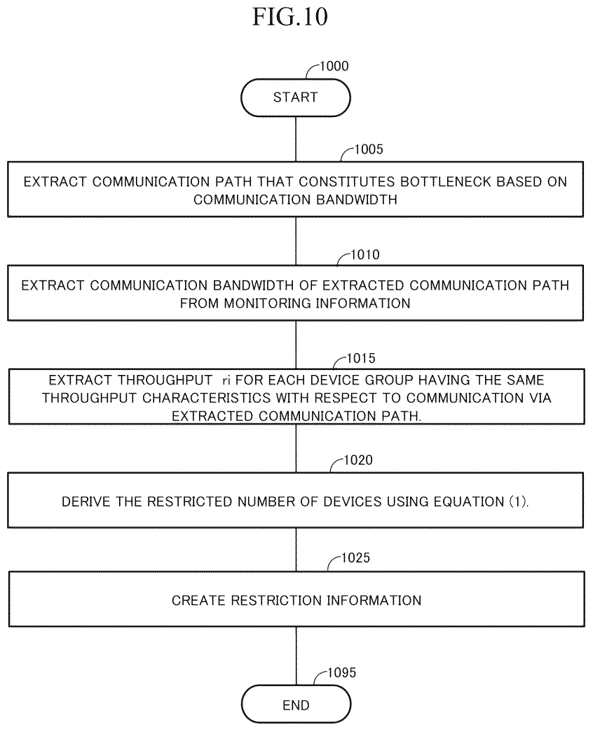

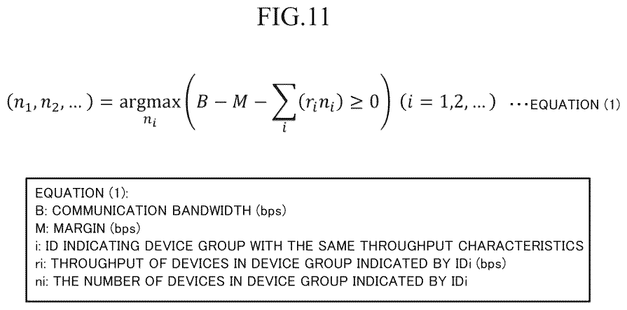

FIG. 10 is a flowchart illustrating the processing flow of step 915 described above, which is executed by the restriction information derivation unit 130. When the support server 100 proceeds to step 915, it starts the process at step 1000 in FIG. 10, sequentially executes the processes from step 1005 to step 1025 as described below, and then proceeds to step 1095 to temporarily terminate the processing flow. Thereafter, the support server 100 proceeds to step 920.
Step 1005: The restriction information derivation unit 130 extracts the communication path that serves as a bottleneck, based on the communication bandwidth, from among the first communication path and the second communication path identified in step 910 of FIG. 9. Note that the extracted path may be at least one of the first communication path and the second communication path.
Step 1010: The restriction information derivation unit 130 extracts the communication bandwidth of the extracted communication path (network) from the monitoring information (communication status information 4000).
Step 1015: The restriction information derivation unit 130 refers to the device management information 5000 and groups the devices (information-providing devices 300) that communicate via the extracted communication path (network) according to identical throughput characteristics (communication performance 5003). An identifier (ID=i) is assigned to each device group, and the throughput (ri) of the devices in the group identified by ID=i is extracted. Note that a fixed value corresponding to the communication performance 5003 may be used as the throughput (ri).
Step 1020: The restriction information derivation unit 130 derives the maximum allowable number of devices for each device group based on Equation (1). That is, Equation (1) is used to determine a combination of the numbers of devices in each group such that the sum of the throughputs of the devices in the combination plus a margin (M) does not exceed the communication bandwidth of the bottleneck communication path, and the sum of the numbers of devices (ni) in the combination is maximized. Note that, instead of the communication bandwidth of the bottleneck communication path, a communication bandwidth calculated based on at least one of the first and second communication paths extracted in step 1005 may alternatively be used.
Step 1025: The restriction information derivation unit 130 generates restriction information based on the derived combination of restricted numbers of devices. An example of the restriction information may be, for instance, “maximum of two in-vehicle cameras” and “maximum of three side cameras”.

### Effects

As described above, the support server 100 according to the embodiment of the present disclosure is capable of assisting in the generation of the prompt(s) for producing support information that takes into account communication restrictions. Furthermore, the support server 100 according to the embodiment of the present disclosure is capable of generating support information in consideration of such communication restrictions and providing the generated support information to the user who requested the support.

### Modified Example 1

In the above-described embodiment, the support request information may include information related to the accuracy of the data. Such information may be, for example, a parameter indicating the accuracy of the data. In this case, the restriction information derivation unit 130 of the support server 100 may set the margin (M) in Equation (1) based on the data accuracy information. The restriction information derivation unit 130 may set the margin (M) to decrease as the data accuracy increases. As a result, the number of devices may be limited according to the data accuracy, and when the data accuracy is high, the amount of data transmitted per device can be increased, thereby enabling the provision of more accurate on-site information (e.g., higher-resolution video images) to the user as part of the second support information.

### Modified Example 2

In the above-described embodiment, when the site is a mobile body such as a vehicle, the storage device 3004 of the support server 100 may store mobile body information including data indicating the position and movement status of the mobile body (e.g., speed, direction, route information, time information, etc.). In this case, the support request information may include information regarding the desired time for providing the operational support information to the user. Based on the mobile body information and the desired provision time, the support server 100 may predict the position of the mobile body at the desired time, generate a restriction prompt based on the communication status at the predicted position of the mobile body at that time, and provide the user with second support information including on-site information corresponding to the predicted mobile body (site).

### Modified Example 3

The support request information may include information regarding the desired duration of data acquisition from the site. In this case, the support server 100 may determine the size of the margin (M) in Equation (1) based on the information regarding the desired data acquisition duration. The restriction information derivation unit 130 of the support server 100 may be configured to increase the margin (M) as the desired data acquisition duration becomes longer. This is because a longer data acquisition duration is more likely to result in greater fluctuations in throughput, thereby necessitating a larger margin (M).

### Other Modified Examples

The present disclosure is not limited to the above-described embodiments and modified examples, and various other modifications may be adopted within the scope of the present disclosure. Furthermore, the above-described embodiments and modified examples may be combined with each other as long as such combinations do not depart from the scope of the present disclosure.

In the above-described embodiment and modified examples, the support server 100 may internally include the generative AI 210. In such a case, the work support system may not include the generative AI server 200.

In the above-described embodiment and modified examples, the support server 100 may be configured to generate a support request prompt based on the support request information and the restriction information.

### REFERENCE SIGNS LIST

100: Support Server
110: Communication Status Monitoring Unit
120: User Prompt Generation Unit
130: Restriction Information Derivation Unit
140: Restriction Prompt Generation Unit
150: Prompt Synthesis Unit
160: Support Information Generation Unit
200: Generative AI Server
210: Generative AI
300: Information-Providing Device
400: User Terminal
4000: Communication Status Information
5000: Device Management Information

1. A prompt generation support apparatus comprising a memory and a processor,
wherein
the memory is configured to store communication status of a communication path used for communication to a user terminal, and a communication path used for communication to a device located at a site, the device being configured to acquire site information related to the site; and
the processor is configured to:
acquire support request information related to a request for operational support from a user;
generate restriction information for limiting the device that acquires the site information based on the communication status of the communication path through which the site information is transmitted; and
generate a support request prompt based on the support request information and the restriction information.

2. The prompt generation support apparatus according to claim 1,
wherein
the memory further stores device management information related to a plurality of devices classified into one or more groups based on throughput; and
the processor is configured to:
acquire communication bandwidth of the communication path through which the site information is transmitted as the communication status; and
generate the restriction information including a combination of the groups and a maximum number of devices in each group such that the total throughput does not exceed the communication bandwidth and a difference between the communication bandwidth and the total throughput is equal to or greater than a predetermined margin.

3. The prompt generation support apparatus according to claim 2,
wherein
the processor uses, as the communication status of at least one communication path for transmitting the site information, the communication status between the device located at the site that is the data acquisition target and the prompt generation support apparatus, and/or the communication status between an environment to which the user terminal belongs and the prompt generation support apparatus, based on the support request information.

4. The prompt generation support apparatus according to claim 2,
wherein
the processor is configured to:
generate a user prompt based on the support request information;
generate a restriction prompt defining restrictions related to the device based on the restriction information; and
generate the support request prompt based on the user prompt and the restriction prompt.

5. The prompt generation support apparatus according to claim 2,
wherein
the support request information includes data accuracy information related to the desired accuracy of data to be acquired from the site; and
the processor is configured to determine the predetermined margin based on the data accuracy information.

6. The prompt generation support apparatus according to claim 2,
wherein
the plurality of the devices include one or more of the devices mounted on a mobile body; and
the site includes the mobile body.

7. The prompt generation support apparatus according to claim 6,
wherein
the memory further stores mobile body information including operational status of the mobile body;
the support request information includes information related to a desired time for providing support information to the user; and
the processor is configured to predict a position of the mobile body at the desired time based on the mobile body information and the desired time information.

8. The prompt generation support apparatus according to claim 2,
wherein
the support request information includes information related to a desired duration of data acquisition from the site; and
the processor is configured to determine the predetermined margin based on the information related to the desired duration of the data acquisition.

9. The prompt generation support apparatus according to claim 2,
wherein
the processor is configured to:
input the support request prompt to a generative AI to thereby acquire first support information including support content generated by the generative AI in response to the support request prompt;
acquire site information corresponding to the first support information from the device; and
generate second support information including the first support information and the site information.

10. A prompt generation support method using a memory and a processor,
wherein
the memory stores communication status of a communication path used for communication to a user terminal, and a communication path used for communication to a device located at a site, the device being configured to acquire site information related to the site, and
the processor acquires support request information related to a request for operational support from a user; generates restriction information for limiting the device that acquires the site information based on the communication status of the communication path through which the site information is transmitted; and generates a support request prompt based on the support request information and the restriction information.
